(19) United States
(12) Patent Application Publication
(10) Pub. No.: US 2003/0193483 A1
(43) Pub. Date: Oct. 16, 2003

(54) Electronic writing & reading board (light) communications system

(76) Inventor: John Neville, Algorta (ES)

Correspondence Address: JOHN NEVILLE, IZARO 2 - 1 B IZDA, ALGORTA, 48991, ES

(21) Appl. No.: 10/342,473

(22) Filed: Jan. 16, 2003

(30) Foreign Application Priority Data
Mar. 22, 2002 (GB) GB 0206760.1

(51) Int. Cl. G09G 5/00

(52) U.S. Cl. 345/173; 345/33

(57) ABSTRACT

Data is generated by writing or drawing on a sheet of paper placed on a specially made electronic writing board having matrixed conductor elements that are connected to the bases of transistors which get triggered and generate data when activated by the lead of a power pencil connected to the positive supply. The data is processed and transmitted. The reading board circuitry receives the signal and after processing it is displayed on the reading board. The system has all the electronic circuitry and memories necessary for its desired satisfactory functioning. Each unit of the system is made up of a writing board and a reading board for real time interactive communication.

In programmable lighting advertisements the data is displayed on a hoarding or any suitable area and a different addressing system is used.

### DESCRIPTION

The invention relates to the production of data in the form of messages and drawings by writing on ordinary writing paper placed on a specially made Electronic Writing Board (EWB), transmitting it through existing means of telecommunications networks to any destination required and displaying it on the Electronic Reading Board (ERB) of the person called. It is also employed to display multicolour lighting advertisements for products and services as well as for decorating buildings and all other applications which require high intensity and colour lighting for special occasions by inputting the required data on electronic advertising colour bulbs matrices connected by cable to the site where it is displayed.

This system sets up instant, simultaneous and interactive written exchange of communication between the sender and the receiver. It is like establishing a telephone conversation with all its advantages PLUS a wide range of other benefits. The written message is silent and bright (white LEDs are used on the reading board) and of course discreet as no one can eaves drop; an advantage of great value in crowded and noisy places or exchange of messages and opinions between, say, a bank manager and his advisor or accountant when the customer is sitting in front of him. It rules out all need for those embarrassing interruptions of answering urgent calls and inter-office communication. All incoming calls can be read on the bright electronic reading board and answers discreetly scribbled on the writing board. All light messages are automatically stored in the memory for future use.

Beside continuous outputting of data by writing on the board, the system bank of memories offer the possibility of saving the whole message however long it may be and then send it all by activating the ‘Send All’ switch thereby reducing telephone cost. The data in the memory can also be printed out using a printer adapted to the system using available technology. The EWB and ERB are adjacent to each other forming a single unit. The dialling is achieved by keying in the number on a single line key arrangement on top of the board. The sender and receiver units are connected using any of the telecommunication systems in use.

To send a message, the user dials the telephone number of the party to be contacted. The call activates the receiver's Light unit, a special tone signifies the incoming call. The telephone number of the sender is displayed and a red Light Emitting Diode switches on. When the receiver presses the red LED button, the sender is alerted and starts writing the message on ordinary writing paper using the Power Pencil. When the receiver is not available (after a number of rings that are programmable), the receiver's memory block records the message as well as the telephone number of the caller and a green LED lights up on the receiver's unit, and stays lit to indicate the presence of the message awaiting to be answered. The incoming messages as well as the outgoing messages are stored in both the senders' and receivers' memory units which can be recalled for any future viewing or processing.

The Light Communication System can also be used in hand held devices with only two dialling keys. Telephone numbers, with cues, can be stored in memory and recalled to choose the required number. The mobile unit will dial the number. These hand held devices have mini writing pad and reading screens as well as memory to store messages. In all other respects they work the same way as the bigger units.

When the sender inputs data the writing appears on the ERB of the receiver as well as on the ERB of the sender. As the receiver writes his reply the ERB of the sender resets and starts to display the incoming message. If the caller is sending drawings or other material to be spontaneously corrected by the receiver, the sender can over ride the reset signal before transmission and view the corrections and scribble his own comments on his EWB, thus establishing a useful dialogue between the two parties. In this way the whole exchange of data is seen clearly on the Electronic Reading Board of both the parties. An animated, simultaneous and considered exchange of technical, financial, medical, legal etc. information can take place in the most appropriate atmosphere facilitating and solving many a problem that can not be solved during a telephone conversation or exchange of faxes. There is no limitation on the size of the EWB and ERB, so the system can be used for very large sheets of paper PLUS the bonus of storing the visual exchange in memory as an interesting record for future pondering.

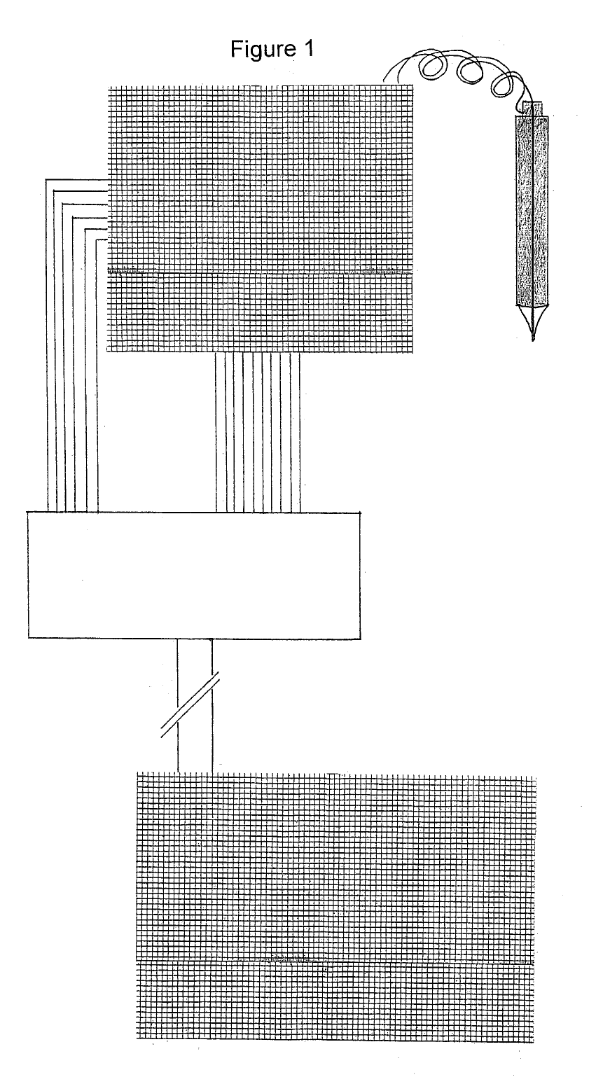

As mentioned above the Light Communications System is also used to write, sketch, draw and display varied patterns for advertising purposes using high voltage and high intensity colour bulbs across the height and breadth of buildings and casinos which now use two or three fixed inflexible patterns which cost a great deal of money to change. It is an ideal system to display advertisements by easily changing text and sketches on the Electronic Writing Board and send the data via cable to the advertising sites where the matrix of colour bulbs plays the role of the Electronic Reading Board. FIG. 1 shows block diagram of the Light Communications System. The electronic writing board comproses of a matrix of highly sensitive NPN transistors with their bases connected to 0.5 to 1 sq. mm highly conductive elements. Each conductive element is separated from the other by nonconducting material on all sides. The surface is well polished and covered by a thin layer of strong, thin, hard and opaque resin. The area of the conductor elements can be increased if so desired, or it may be further decreased to any size feasible depending on the degree of resolution desired. Each transistor has one collector and two emitters (or 2 equal transistors may be used). The collectors of all the transistors in the matrix are connected to the positive power supply. In the matrix we have rows and columns. All the emitters of the transistors belonging to row 1 are connected through a single conductor rail to that row's amplifying circuit whose amplified output is connected to the first input of the mulplexer. The emitters of row 2 are similarly connected to its amplification circuit whose output goes to the second input of the multiplexer. All the rows are similary connected and inputted to the row-multiplexer. The 2^{nd} emitters that belong to the 1^{st} column transistors are connected to that column's signal rail and conducted to its amplifier circuit and then outputted to the 1^{st} input of the column-multiplexer. Likewise each and every column is connected to its own dedicated amplification circuitry and then inputted to the column-multiplexer.

When connected to power, a yellow LED lights up and stays on. A sheet of ordinary writing paper is placed on the Electronic Writing Board and the desired message, sketch or drawing is written using a power pencil whose graphite core is connected to the positive supply. When the graphite tip writes on the paper then the bases of twin emitter transistors (or bases of two transistors) connected to the squares they touch receive a positive voltage pulse and switch on. Signals emanating from the emitters of the conducting transistors are carried by their respective row and column signal buses to their respective amplification circuits. The amplified signals are then connected to the independent input pins of the analogue column and row multiplexers. The binary addresses for the row and column multiplexers are produced by binary counters which receive clock pulses from a frequency generator. The data is multiplexed and outputted serially by the rows and columns multiplexers. It is now available for processing and transmission to the Light Communications Unit of the receiver.

When the Light Communication system is used to light up five different colour bulbs on displays, then each transistor in the Electronic Writing Board has one collector and five emitters (or 5 transistors with all collectors connected) and five separate signal carrying buses for rows and columns respectively, each dedicated to a single colour. Switches on the EWB are used to enable or disable any colour transmission and thus produce patterns of chosen colours. All colour inputs have their own dedicated circuitry in the Light Comminations System. All data inputted is multiplexed, encoded and conducted by cable (or wireless) to the advertisement sights where the receiving system decodes, demultiplexes and activates the corresponding row and column triacs to switch on the high intensity, high voltage colour bulbs corresponding to the to the design sketched on the paper placed on the Electronic Writing Board. Thus making it the most versatile manner of advertisement display with enormous advantages and minimal cost.

The electronic display board comprises of lighting elements (bright white LEDs) arranged in a matrix whose numbers and arrangement in rows and columns is identical to that of the metal squares in the electronic writing board. The signal is received, decoded, demodulated and demultiplexed. The output of the demultiplexers is stored in the columns and rows memories.

Data from the row demultiplexers activates the gates of the row triacs and that from the column demultiplexers the gates of the column triacs, thus switching on the bulbs corresponding to the squares that were switched on the writing board elements.

The graphite lead of the pencil is connected to the positive of the DC power supply. The metal case of the pencil is connected to the negative and the space between the graphite lead and metal case is well insulated. This pencil is connected to the circuitry of the system by a cable. The core of the pencil consists of a metal holder with a small set of jaws at the writing end which holds the graphite lead that can be moved down or replaced by pressing down on the sprung plunger with the thumb to open the jaws and then released. This arrangement allows for the use of graphite leads of any chosen diameter. The plunger is fixed to the insulated top of the pencil.

1. The light communications system has a matrix writing board made of mutually insulated conductor elements that are connected to the bases of their respective columns and rows transistors which generates data when texts, sketches and drawings are written on the paper placed on it.

2. The light communications system has a receiver, the reading board, configured in an identical manner as the writing board with light elements, replacing conductor elements and transistors, which light up to display the written data transmitted from the writing board.

3. Each communication unit is made up of a writing and reading board, side by side in a single mould, with a power graphite pencil connected to the positive of the power supply whose lead is easily replaceable and can be of any desired thickness.

4. The writing board as claimed in claim 1 has two memory blocks, one stores the data inputted by the sender's board and the other stores incoming data from the calling party.

5. The writing board as claimed in claim 1 can be made to transmit data of very high resolution by increasing the number of its conductor elements and reducing the area of each element to the degree of resolution desired.

6. The reading board as claimed in claim 2 has bright white LEDs whose size as well as interspacing can be reduced to the minimum to match the resolution of a high quality photograph.

7. A system as claimed in claim 1 and 2 serves interdepartmental office applications when telephone conversation is not a discreet medium and the situation requires very confidential exchange with a member of staff that should not be heard by the party present in the office who is the subject of the inquiry; in noisy environment or when silent exchange of messages is required.

8. A system as claimed in claim 1 whose data is processed, multiplexed, encoded and transmitted by cable or transmitted using any of the various telecommunications technologies available.

9. The writing board as claimed in claim 1 can have seven transistors to each conductor element, each corresponding to a chosen color for transmission where all the colors can be switched on manually or just the desired colors switched on.

10. The reading board as claimed in claim 2 can have seven color light elements or high voltage high intensity light bulbs to display color drawings and data on huge advertisement hoarding on buildings etc. where the reading board is the whole area occupied by the advertisement itself, thus making it a completely flexible programmable advertising and publicity system controlled from the writing board.

11. The writing and reading board as claimed in claims 1 and 2 can be miniaturized to pocketsize light communication system that is easy to carry around, send and receive messages of any length and providing satisfactory interaction between the sender and the receiver.

12. The writing and reading boards as claimed in claims 1 and 2 can be used in dark conditions such as a battlefield at night or even during the day to communicate silently and sketch the terrain and other important factors that are difficult to describe by soldiers whose language skills are limited.

13. A system as claimed in claim 1 whose data can be printed out on an electronic printer using suitable interface.
